(19) United States
(12) Patent Application Publication
(10) Pub. No.: US 2002/0044127 A1
(43) Pub. Date: Apr. 18, 2002

(54) Display apparatus and driving method therefor

(76) Inventors: Katsuhide Uchino, Kanagawa (JP); Tomohiro Kashima, Tokyo (JP); Junichi Yamashita, Tokyo (JP)

Correspondence Address: RADER, FISHMAN & GRAUER, P.L.L.C., Suite 501, 1233 20th Street, NW, Washington, DC, 20036, US

(21) Appl. No.: 09/897,487

(22) Filed: Jul. 3, 2001

(30) Foreign Application Priority Data
Jul. 7, 2000 (JP) P2000-206225

(51) Int. Cl. G09G 3/36

(52) U.S. Cl. 345/98; 345/99

(57) ABSTRACT

A display apparatus of the active matrix type using a point sequential driving method is disclosed wherein a sufficient writing time can be assured for a pixel on the scanning ending end side in the horizontal direction even where the horizontal blanking period is short to achieve a high picture quality free from shading. Gate lines of a pixel section are cut leftwardly and rightwardly at central portions thereof to form left side gate lines and right side gate lines, and a pair of vertical driving circuits are disposed on the opposite left and right sides of the display section. Scanning pulse signals for the left side are successively outputted from the left side vertical driving circuit and applied to the left side gate lines. Scanning pulse signals for the right side having phases delayed from those of the scanning pulse signals for the left side are successively outputted from the right side vertical driving circuit and applied to the right side gate lines.

### BACKGROUND OF THE INVENTION

This invention relates to a display apparatus and a driving method therefor, and more particularly to a display apparatus of the active matrix type which uses a point sequential driving method and a driving method for the display apparatus.

A point sequential driving method is available as one of driving methods for a display apparatus such as, for example, a liquid crystal display apparatus of the active matrix type which uses a liquid crystal cell as a display element of a pixel. According to the point sequential driving method, a scanning pulse signal of a fixed pulse width is successively generated by vertical scanning and applied to a gate line wired for each of rows of a pixel section, which includes pixels arranged in rows and columns, to select those pixels of the row connected to the gate line for a fixed period while a video signal is successively supplied through a signal line wired for each of the columns by horizontal scanning thereby to write the video signal successively into the pixels of the rows in a unit of a row.

In the liquid crystal display apparatus of the active matrix type which uses the point sequential driving method, since a video signal is written, upon horizontal scanning, in order into the pixels of one row, which is kept in a selected state for a fixed period of time, beginning with the left end pixel, as apparently seen from FIG. 7, whereas the time within which the video signal is written into a pixel on the scanning starting end side of the row is very long, it is very short on the scanning ending end side.

As described above, in the liquid crystal display apparatus of the active matrix type which uses the point sequential driving method, since the writing time into a pixel on the scanning ending end side for one row is very short when compared with the writing time into a pixel on the scanning starting end side, where the number of pixels in the horizontal direction is great and the horizontal blanking period is short as in the UXGA (Ultra Extended Graphics Array) format or the HD (High Definition) 1018I format, a sufficient writing time into a pixel on the scanning ending end side cannot be assured accordingly. This gives rise to failure in full writing of the video signal, resulting in appearance of shading and hence in deterioration of the picture quality.

Further, a liquid crystal display apparatus of the active matrix type usually adopts a driving method wherein the polarity of a video signal to be written into pixels is reversed for each 1H (H represents a horizontal scanning period) with respect to a common voltage Vcom which is a predetermined dc voltage. In recent years, in order to raise the contrast of a liquid crystal panel, there is a tendency to increase the amplitude of the video signal with respect to the common voltage Vcom (for example, 7.5 V) from a conventional voltage of 4.5 V to 5.5 V.

Where the amplitude of the video signal with respect to the common voltage Vcom increases in this manner, for example, if the amplitude is increased to 5.5 V, then the high level side voltage of the video signal becomes as high as 13 V (=7.5 V+5.5 V) and the potential difference of the voltage from the potential of a gate line which is, for example, 15.5 V becomes very small. Therefore, the video signal is liable to fail to be written sufficiently into a pixel on the scanning ending end side for which a sufficient writing time cannot be assured.

### SUMMARY OF THE INVENTION

It is an object of the present invention to provide a display apparatus and a driving method therefor wherein a sufficient writing time can be assured for a pixel on the scanning ending end side in the horizontal direction even where a format which uses a comparatively short horizontal blanking period is used to achieve a high picture quality free from shading.

In order to attain the object described above, according to an aspect of the present invention, there is provided a display apparatus, comprising a pixel section including a plurality of pixels arranged in rows and columns, signal lines wired individually for the columns of the pixels and gate lines wired individually for the rows of the pixels, the gate lines being cut leftwardly and rightwardly at central portions thereof to form first and second gate lines, first vertical driving means disposed on one side of the pixel section in a horizontal direction for successively applying a first scanning pulse signal to the first gate lines, second vertical driving means disposed on the other side of the pixel section in the horizontal direction for successively applying a second scanning pulse signal, which has a phase delayed from that of the first scanning pulse signal, to the second gate lines, and horizontal driving means for successively supplying a video signal through the signal lines to those of the pixels which are connected to the first and second gate lines to which the first and second scanning pulse signals are applied from the first and second vertical driving means, respectively.

According to another aspect of the present invention, there is provided a driving method for a display apparatus which includes a pixel section including a plurality of pixels arranged in rows and columns, signal lines wired individually for the columns of the pixels and gate lines wired individually for the rows of the pixels, comprising the steps of, the gate lines of the pixel section being cut leftwardly and rightwardly at central portions thereof to form first and second gate lines, successively supplying, upon vertical scanning, a first scanning pulse signal to the first gate lines, successively supplying, upon vertical scanning, a second scanning pulse signal, which has a phase delayed from that of the first scanning pulse signal, to the second gate lines, and successively supplying a video signal through the signal lines to those of the pixels which are connected to the first and second gate lines to which the first and second scanning pulse signals are supplied, respectively.

In the display apparatus and the driving method for a display apparatus, vertical scanning of the first and second gate lines separate leftwardly and rightwardly from each other is performed by the first and second vertical driving means, respectively. Then, upon vertical scanning, the first vertical driving means successively applies the first scanning pulse signal to the first gate lines, and the second vertical driving means successively applies the second scanning pulse signal, whose phase is delayed from that of the first scanning pulse signal, to the second gate lines. Consequently, a sufficient writing time can be assured for a pixel on the scanning ending end side in the horizontal direction. Therefore, even where a format which uses a short horizontal blanking period is used, a high picture quality free from shading can be achieved.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a circuit diagram showing an example of configuration of a liquid crystal display apparatus of the active matrix type using a point sequential driving method to which the present invention is applied;

FIG. 2 is a block diagram showing an example of particular circuit configuration of a vertical driving circuit shown in FIG. 1;

FIG. 3 is a timing chart illustrating operation of the vertical driving circuit of FIG. 2;

FIG. 4 is a block diagram showing another particular circuit configuration of the vertical driving circuit of FIG. 2;

FIG. 5 is a timing chart illustrating a phase relationship of a left side scanning pulse signal and a right side scanning pulse signal;

FIG. 6 is a timing chart illustrating a writing time into a pixel at the scanning ending end side of a row in the liquid crystal display apparatus of FIG. 1; and

FIG. 7 is a timing chart illustrating a writing time into a pixel at the scanning ending end side of a row in a conventional display apparatus.

### DESCRIPTION OF THE PREFERRED EMBODIMENT

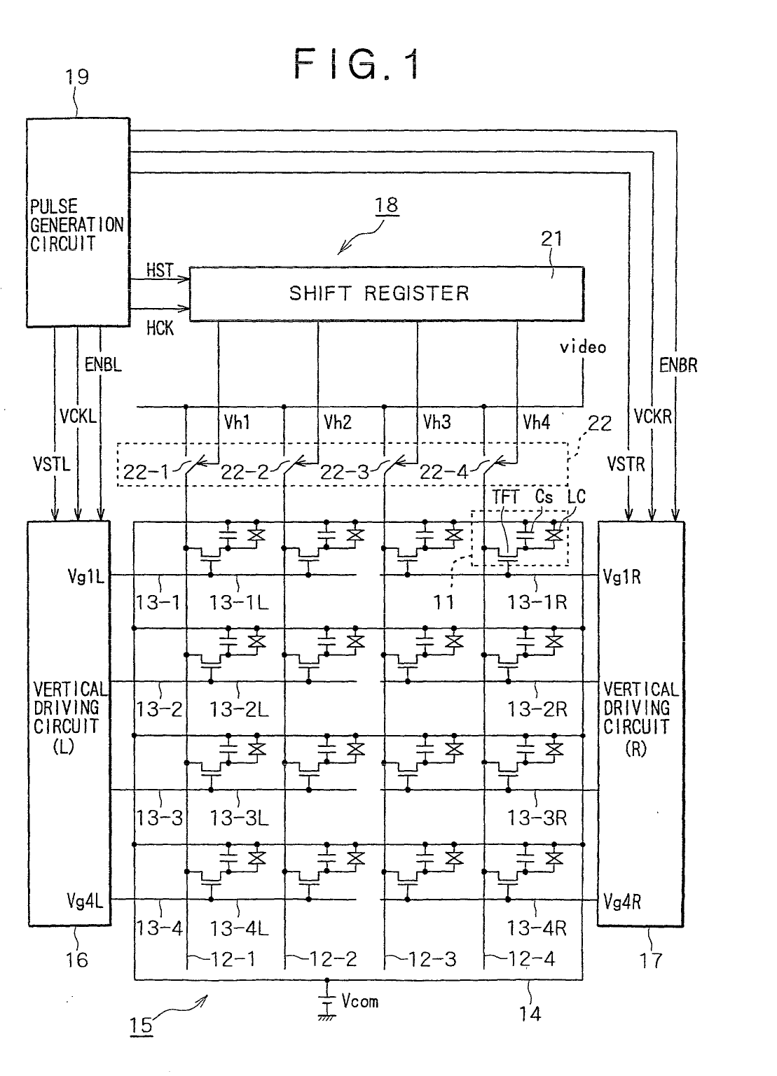

Referring first to FIG. 1, there is an example of configuration of a liquid crystal display apparatus of the active matrix type using the point sequential driving method to which the present invention is applied. The liquid crystal display apparatus is shown including a pixel arrangement of four rows and four columns for simplified illustration and description. Further, the active matrix type liquid crystal display apparatus uses a thin film transistor (TFT) as a switching element for each pixel similarly as in popular liquid crystal display apparatus of the type described.

The liquid crystal display apparatus includes pixels 11 for four rows and four columns arranged in a matrix. Each pixel 11 includes a thin film transistor TFT serving as a pixel transistor, a liquid crystal cell LC having a pixel electrode connected to the drain electrode of the thin film transistor TFT, and a holding capacitor Cₛ having an electrode connected to the drain electrode of the thin film transistor TFT.

To the pixels 11, signal lines 12-1 to 12-4 are wired along the pixel arrangement direction for the individual columns and gate lines 13-1 to 13-4 are wired along the pixel arrangement direction for the individual rows. The gate lines 13-1 to 13-4 are cut leftwardly and rightwardly at central portions thereof. Of the gate lines 13-1 to 13-4 cut to left and the right, the gate lines on the left side in FIG. 1 are hereinafter referred to as gate lines 13-1L to 13-4L and the gate lines on the right side in FIG. 1 are hereinafter referred to as gate lines 13-1R to 13-4R.

In each pixel 11, the source electrode (or drain electrode) of the thin film transistor TFT is connected to a corresponding one of the signal lines 12-1 to 12-4. The gate electrode of the thin film transistor TFT is connected to a corresponding one of the gate lines 13-1L to 13-4L and the gate lines 13-1R to 13-4R. An opposing electrode of the liquid crystal cell LC and the other electrode of the holding capacitor Cₛ are connected to a Cₛ line 14 commonly among the pixels. A predetermined dc voltage (for example, 7.5V) is applied to the Cₛ line 14 as a common voltage Vcom.

Thus, a pixel section 15 is configured wherein the pixels 11 are arranged in a matrix and the signal lines 12-1 to 12-4 are wired to the pixels 11 for the individual columns and the gate lines 13-1L to 13-4L and the gate lines 13-1R to 13-4R are separated leftwardly and rightwardly, respectively, and wired to the pixels 11 for the individual rows.

A pair of vertical driving circuits 16 and 17 are arranged on the opposite sides of the pixel section 15 in a horizontal direction, that is, on the opposite left and right sides of the pixel section 15, respectively. One end of each of the gate lines 13-1L to 13-4L which are the left side gate lines of the pixel section 15 is connected to an output terminal of the vertical driving circuit (L) 16 for a row. Meanwhile, one end of each of the gate lines 13-1R to 13-4R which are the right side gate lines of the pixel section 15 is connected to an output terminal of the vertical driving circuit (R) 17 for a row.

The vertical direction (a direction of a column) for each one field period to successively select the pixels 11 which are connected to the gate lines 13-1L to 13-4L and the gate lines 13-1R to 13-4R in a unit of a row. A particular configuration and operation of the vertical driving circuits 16 and 17 are hereinafter described in detail.

A horizontal driving circuit 18 is arranged, for example, on the upper side of the pixel section 15 in FIG. 1. A pulse generation circuit 19 generates several different pulse signals to be used by the vertical driving circuits 16 and 17 and the horizontal driving circuit 18. More particularly, the pulse generation circuit 19 generates pulse signals including first and second vertical start pulse signals VSTL and VSTR, first and second vertical clock signals VCKL and VCKR, first and second enable pulse signals ENBL and ENBR, a horizontal start pulse signal HST, and a horizontal clock signal HCK.

The first and second vertical start pulse signals VSTL and VSTR, the first and second vertical clock signals VCKL and VCKR and the first and second enable pulse signals ENBL and ENBR have phases displaced by a predetermined time from each other. More particularly, the vertical start pulse signal VSTR, vertical clock signal VCKR and enable pulse signal ENBR to be used for the right side vertical driving circuit 17 have phases delayed by a predetermined time, preferably approximately (½)H, from the phases of the vertical start pulse signal VSTL, vertical clock signal VCKL and enable pulse signal ENBL to be used for the left side vertical driving circuit 18.

The horizontal driving circuit 18 successively samples a video signal video for each 1H to write the video signal video into the pixels 11 selected in a unit of a row by the vertical driving circuit 16 or 17. The horizontal driving circuit 18 includes a shift register 21 and a sampling switch set 22.

The shift register 21 includes a number of shift stages equal to the horizontal pixel number/simultaneous sampling number of the pixel section 15 (for example, if the horizontal pixel number is 1,024 and 12 dots are sampled at the same time, then 1024/12=85 with four left over, and therefore, 86 shift stages) and performs a shifting operation synchronized with the horizontal clock signal HCK when the horizontal start pulse signal HST is inputted thereto. Consequently, a shift pulse having a pulse width same as a cycle of the horizontal clock signal HCK is outputted successively. The shift pulses are applied as sampling pulses Vh1 to Vh4 to the sampling switch set 22.

The sampling switch set 22 includes four switches 22-1 to 22-4 corresponding to the pixel columns of the pixel section 15. One terminal of each of the switches 22-1 to 22-4 is connected to a video line 23 for inputting the video signal video and the other terminal is connected to an end of a corresponding one of the signal lines 12-1 to 12-4 of the pixel section 15. If the sampling pulses Vh1 to Vh4 are applied from the shift register 21 to the switches 22-1 to 22-4, then the switches 22-1 to 22-4 are successively switched on in response to the sampling pulses Vh1 to Vh4, respectively. Consequently, the video signal video inputted through the video line 23 is successively sampled and supplied to the signal lines 12-1 to 12-4.

An example of particular configuration of the vertical driving circuit 16 and 17 is described. It is to be noted that, since the vertical driving circuit 16 and 17 have the same circuit configuration description here is given taking the vertical driving circuit 16 as an example. Further, as the first vertical clock signal VCKL, vertical clock signals VCKL and VCKXL having phases opposite to each other are used. Also as the second vertical clock signal VCKL, vertical clock signals VCKR and VCKXR having phases opposite to each other are used similarly to the first clock signal VCKL.

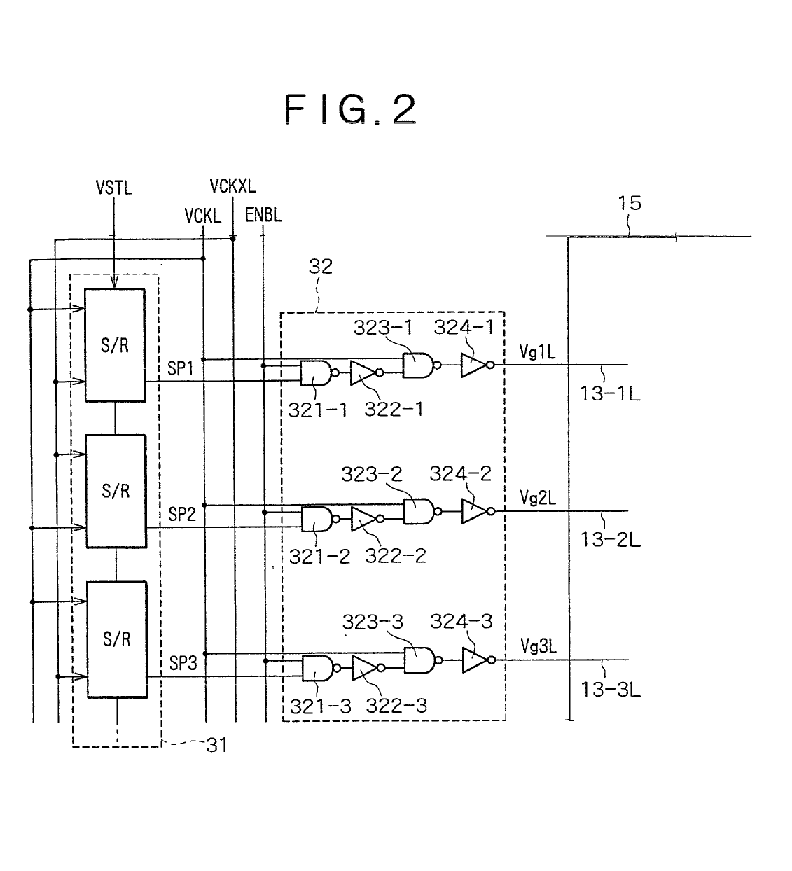

FIG. 2 shows an example of circuit configuration of the vertical driving circuit 16. Referring to FIG. 2, the vertical driving circuit 16 includes a shift register 31 and a logic gate circuit 32.

The shift register 31 includes a number of shift stages (S/R stages) corresponding to the number of pixels of the pixel section 15 in the vertical direction. If the vertical start pulse VSTL is applied to the shift register 31, then the shift register 31 performs a shifting operation synchronized with the vertical clock signals VCKL and VCKXL of the phases opposite to each other. Consequently, shift pulses SP1, SP2.: SP3, . . . which have a pulse width equal to the period of the vertical clock signals VCKL and VCKXL are successively outputted from the shift stages of the shift register 31.

The logic gate circuit 32 includes NAND gates 321-1, 321-2, 321-3, . . . , inverters 322-1, 322-2, 322-3, . . . , NAND gates 323-1, 323-2, 323-3, . . . , and inverters 324-1, 324-2, 324-3, . . . which are provided corresponding to the shift stages of the shift register 31.

In the logic gate circuit 32, the NAND gates 321-1, 321-2, 321-3, . . . receive shift pulses SP1, SP2, SP3, outputted from the first, second, third, . . . shift stages of the shift register 31 each at an input terminal thereof and receive the enable pulse signal ENBL each at the other input terminal thereof. Output pulses of the NAND gates 321-1, 321-2, 321-3, . . . are inverted by the inverters 322-1, 322-2, 322-3, . . . , and resulting pulses are inputted to input terminals of the NAND gates 323-1, 323-2, 323-3, . . . on one side.

The NAND gates 323-1, 323-2, 323-3, . . . receive the vertical clock signals VCKL and VCKXL of the opposite phases to each other at the other input terminals thereof. In particular, the NAND gate 323-1 receives the vertical clock signal VCKL, the NAND gate 323-2 receives the vertical clock signal VCKXL, and the NAND gate 323-3 receives the vertical clock signal VCKL, each at the other input terminal thereof.

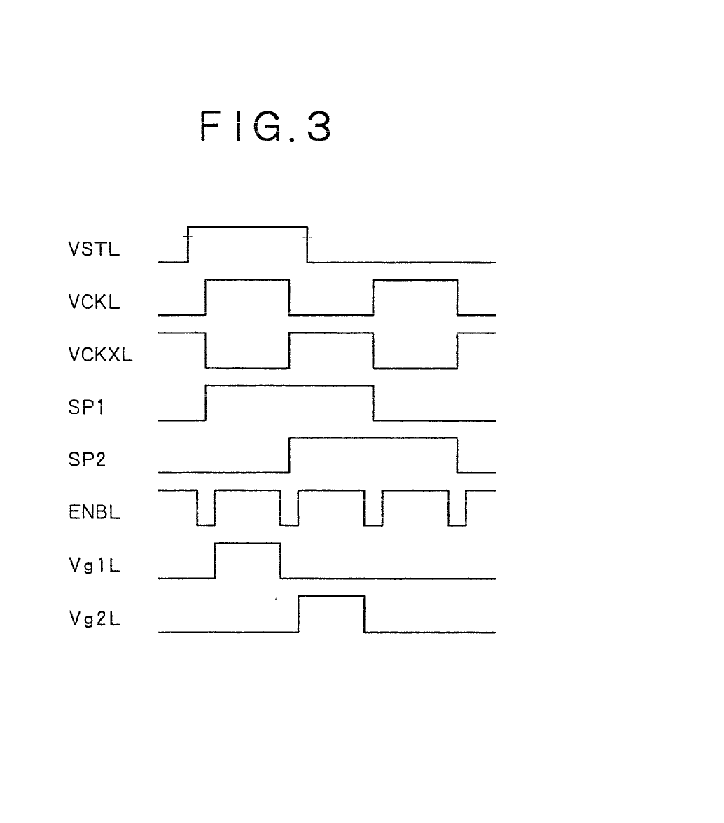

Output pulses of the NAND gates 323-1, 323-2, 323-3, . . . are inverted by the inverters 324-1, 324-2, 324-3, . . . to form scanning pulse signals VgiL, Vg2L, Vg3L, . . . -which are applied to the gate lines 13-1L, 13-2L, 13-3L, . . . of the pixel section 15, respectively. FIG. 3 illustrates a relationship of timings of the vertical start pulse signal VSTL, vertical clock signal VCKL and VCKXL, shift pulses SP1 and SP2, enable pulse signal ENBL, and scanning pulse signals Vg1L and Vg2L.

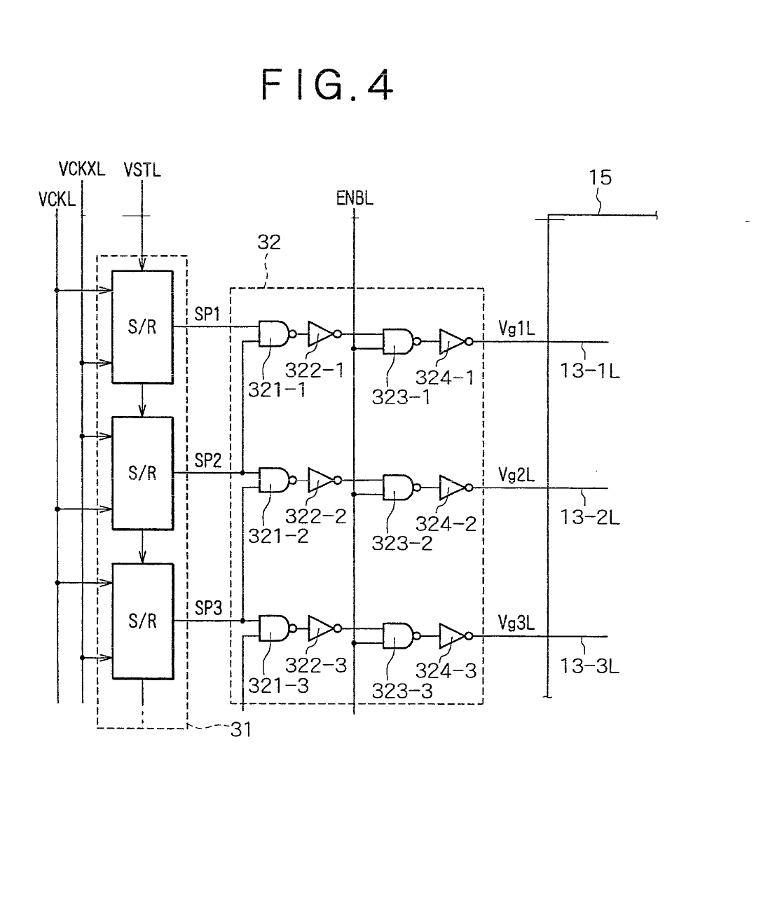

It is to be noted that, while the logic gate circuit 32 shown in FIG. 2 has a circuit configuration which logically NANDs the shift pulses SP1, SP2, . . . and the enable pulse signal ENBL, it does not necessarily have the specific circuit configuration. For example, it may have another configuration wherein it logically NANDs the shift pulses SP1, SP2, . . . and the vertical clock signals VCKL and VCKXL and then logically NANDs results of the NANDing and the enable pulse signal ENBL. Alternatively, it may have a further configuration wherein it logically NANDs adjacent ones of the shift pulses such as the shift pulses SP1 and SP2, shift pulses SP2 and SP3, . . . and then logically NANDs results of the NANDing and the enable pulse signal ENBL. A detailed circuit configuration of the logic gate circuit 32′ in this instance is shown in FIG. 4.

Also the vertical driving circuit 17 on the right Side is configured quite similarly to the vertical driving circuit 16 on the left side and produces scanning pulse signals Vg1R, Vg2R, Vg3R, . . . based on the vertical start pulse signal VSTR, the vertical clock signals VCKR and VCKXR which have the opposite phases to each other, and the enable pulse signal ENBR. The scanning pulse signals Vg1R, Vg2R, Vg3R, . . . are supplied to the gate lines 13-1R, 13-2R, 13-3R, . . . , respectively.

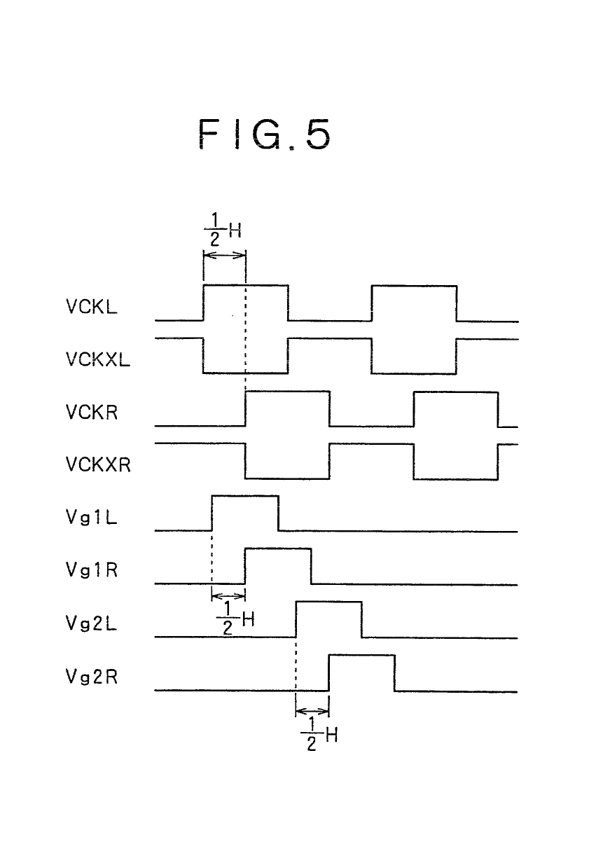

As described hereinabove, the vertical start pulse signal VSTR, vertical clock signals VCKR and VCKXR, and enable pulse signal ENBR for the right side have phases delayed by, for example, approximately (½)H from those of the vertical start pulse signal VSTL, vertical clock signals VCKL and VCKXL, and enable pulse signal ENBL, respectively. Therefore, as seen from the timing chart of FIG. 5, also the scanning pulse signals Vg1R, Vg2R, . . . for the right side are delayed in phase by approximately (½)H from the scanning pulse signals Vg1L, Vg2L, . . . for the left side, respectively.

Where the gate lines 13-1, 13-2, . . . of the pixel section 15 are cut leftwardly and rightwardly at central portions thereof to form the gate lines 13-1L to 13-4L on the left side and the gate lines 13-1R to 13-4R on the right side and the vertical driving circuit 16 and 17 are disposed on the opposite left and right sides of the pixel section 15 and besides the scanning pulse signals Vg1L to Vg4L are successively outputted from the vertical driving circuit 16 and applied to the gate lines 13-1L to 13-4L, respectively, while the scanning pulse signals Vg1R to Vg4R having phases delayed by approximately (½)H from those of the scanning pulse signals Vg1L to Vg4L are successively outputted from the vertical driving circuit 17 and applied to the gate lines 13-1R to 13-4R, respectively, in this manner, the writing time into a scanning ending end side pixel in each row can be assured sufficiently.

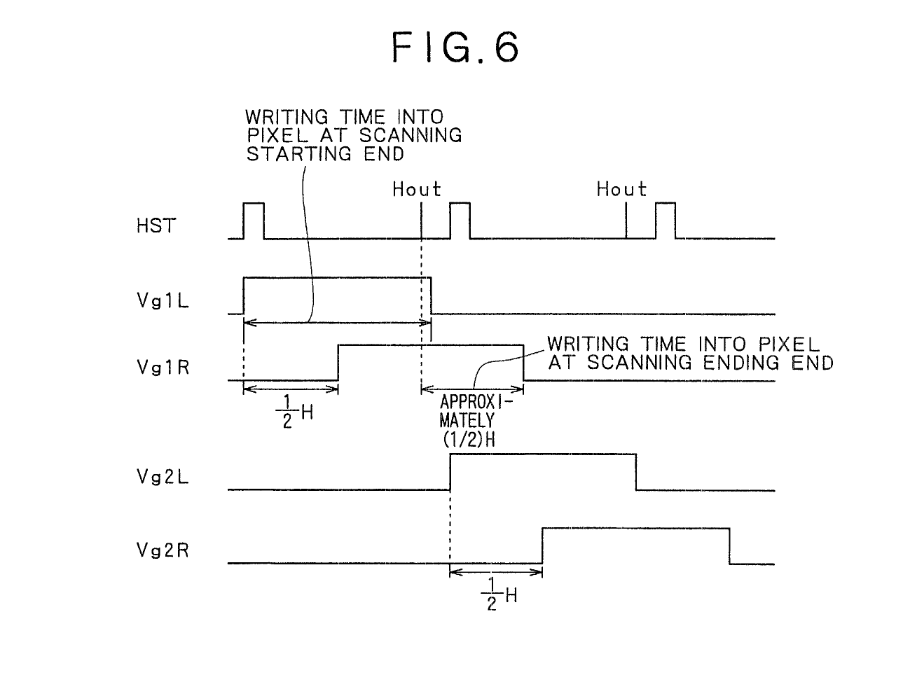

In particular, if notice is taken of writing of the video signal video into the pixels of the first row, when the scanning pulse signal Vg1L is applied to the gate line 13-1L on the left side and horizontal driving by the horizontal driving circuit 18 is started in response to the horizontal start pulse HST as seen in FIG. 6, writing of the video signal video is performed successively beginning with the leftmost pixel of the first row, that is, the first pixel of the first row in the horizontal scanning direction.

Then, at a point of time when the writing comes to a pixel in the proximity of the center of the first row, that is, when time of approximately (½)H elapses after the start of the writing of the first row, the scanning pulse signal Vg1R is applied to the gate line 13-1R on the right side. Consequently, subsequently to the writing into the rightmost one of the pixels connected to the gate line 13-1L, writing of the video signal video is performed successively into the pixels connected to the gate line 13-1R beginning with the leftmost one of the pixels.

Since the pulse width of the scanning pulse signal Vg1R is equal to the pulse width of the scanning pulse signal Vg1L, the last sampling timing by the shift register 21 of the horizontal driving circuit 18, in the present example, the generation timing of the sampling pulse Vh4, and in the timing chart of FIG. 6, the timing indicated by Hout, is given as a timing at approximately one half the pulse width of the scanning pulse signal Vg1R.

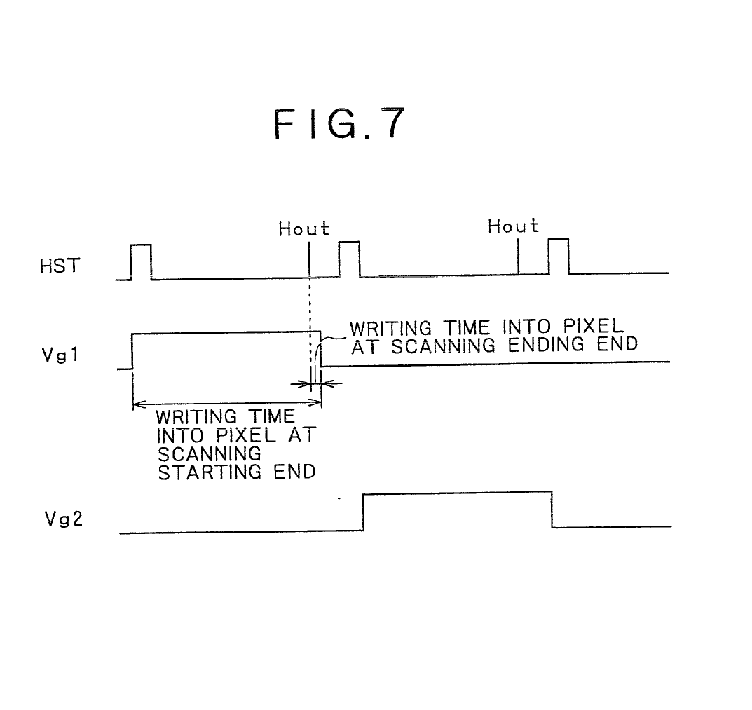

As apparent from this, the writing time of the video signal video for the rightmost pixel of the first row, that is, for the pixel at the scanning ending end of the first row, is given as a period of a pulse width corresponding to the rear half of the scanning pulse signal Vg1R from the last sampling timing Hout of the first row, that is, approximately (½)H. Accordingly, as apparent from the comparison with the timing chart of FIG. 7 which illustrates similar timings of operation of a conventional display apparatus, the writing time for the pixel at the scanning ending end of the first row can be assured sufficiently.

Consequently, even if the pixel number in the horizontal direction is comparatively great and the horizontal blanking period is comparatively short like the UXGA format (horizontally 1,600 pixels×vertically 1,200 pixels) or the HD 1080I format (horizontally 1,920 pixels×vertically 1,080 pixels), insufficient writing of the video signal video for a pixel at the scanning ending end does not occur, and consequently, shading can be suppressed.

Particularly where, a liquid crystal display apparatus of the active matrix type which adopts a driving method wherein the polarity of a video signal to be written into pixels is reversed for each 1H with respect to a common voltage Vcom (for example, 7.5 V) is configured such that, in order to raise the contrast, the amplitude of the video signal video with respect to the common voltage Vcom is increased, for example, to 5.5 V, even if the potential difference between the high level side of the video signal video and the potential (for example, 15.5 V) of the gate lines becomes very small, a sufficient writing time can be assured. Therefore, insufficient writing of the video signal video into a pixel at the scanning ending end side does not occur.

It is to be noted that, while, in the embodiment described above, the phases of the scanning pulse signals Vg1R, Vg2R, . . . for the right side are delayed by approximately (½)H from the phases of the scanning pulse signals Vg1L, Vg2L, . . . for the left side, the phase delay is not limited to the specific period of (½)H, and even if the phase delay is within (½)H, the writing time for a pixel at the scanning ending end for one row can be increased by a time equal to the phase delay. However, as apparent from the foregoing description of operation, it is a requirement in this instance that, upon horizontal scanning for pixels for one row, the scanning pulse signals Vg1R, Vg2R, . . . for the right side be generated before the writing timing for the first pixel on the right side in the horizontal scanning direction comes.

Further, in the embodiment described above, the present invention is applied to a liquid crystal display apparatus which includes an analog interface driving circuit which receives an analog video signal as an input thereto and samples the analog video signal to drive the pixels in a point sequential relationship. However, the present invention can be similarly applied also to a ii liquid crystal display apparatus which receives a digital video signal as an input thereto, latches once and then converts the digital video signal into an analog video signal and samples the analog video signal to drive the pixels in a point sequential relationship.

Furthermore, in the embodiment described above, the present invention is applied to a liquid crystal display apparatus which uses a liquid crystal cell as a display element of a pixel. However, the application of the present invention is not limited to a liquid crystal display apparatus, but the present invention can be applied to any display apparatus of the active matrix type which uses the point sequential driving method.

As the point sequential driving method, in addition to the 1H inversion driving method and the dot inversion driving method which are well known in the art, a dot line inversion driving method is available wherein video signals of the opposite polarities are written at a time into pixels in two adjacent pixel columns in two rows spaced by a distance corresponding to an odd number of rows from each other, for example, in two upper and lower adjacent rows, so that, in the pixel array after a video signal is written into the pixels, two adjacent left and right pixels have the same polarity but two adjacent upper and lower pixels have the opposite polarities.

While a preferred embodiment of the present invention has been described using specific terms, such description is for illustrative purposes only, and it is to be understood that changes and variations may be made without departing from the spirit or scope of the following claims.

What is claimed is:

1. A display apparatus, comprising:
a pixel section including a plurality of pixels arranged in rows and columns, signal lines wired individually for the columns of said pixels and gate lines wired individually for the rows of said pixels, said gate lines being cut leftwardly and rightwardly at central portions thereof to form first and second gate lines;
first vertical driving means disposed on one side of said pixel section in a horizontal direction for successively applying a first scanning pulse signal to said first gate lines;
second vertical driving means disposed on the other side of said pixel section in the horizontal direction for successively applying a second scanning pulse signal, which has a phase delayed from that of the first scanning pulse signal, to said second gate lines; and
horizontal driving means for successively supplying a video signal through said signal lines to those of said pixels which are connected to the first and second gate lines to which the first and second scanning pulse signals are applied from said first and second vertical driving means, respectively.

2. A display apparatus according to claim 1, wherein said second vertical driving means generates the second scanning pulse signal after the first scanning pulse signal is generated but prior to a writing timing into a first pixel in the horizontal scanning direction from among the pixels connected to each of said second gate lines.

3. A display apparatus according to claim 2, wherein the phase delay of the second scanning pulse signal from the first scanning pulse signal is approximately one half a horizontal scanning period.

4. A display apparatus according to claim 2, wherein said first vertical driving means includes a shift register which, when a first vertical start pulse is applied thereto, successively shifts the first vertical start pulse in synchronism with the first vertical clock signal and successively outputs the first vertical start pulse as shift pulses to be used as a reference for the first scanning pulse signal from individual shift stages thereof, and said second vertical driving means includes a shift register which, when a second vertical start pulse having a phase delayed from that of the first vertical start pulse is applied thereto, successively shifts the second vertical start pulse in synchronism with the second vertical clock signal, whose phase is delayed from that of the first vertical clock signal, and successively outputs the second vertical start pulse as shift pulses to be used as a reference for the second scanning pulse signal from individual shift stages thereof.

5. A display apparatus according to claim 1, wherein display elements of the pixels are liquid crystal cells.

6. A driving method for a display apparatus which includes a pixel section including a plurality of pixels arranged in rows and columns, signal lines wired individually for the columns of said pixels and gate lines wired individually for the rows of said pixels, comprising the steps of:
said gate lines of said pixel section being cut leftwardly and rightwardly at central portions thereof to form first and second gate lines;
successively supplying, upon vertical scanning, a first scanning pulse signal to said first gate lines;
successively supplying, upon vertical scanning, a second scanning pulse signal, which has a phase delayed from that of the first scanning pulse signal, to said second gate lines; and
successively supplying a video signal through said signal lines to those of said pixels which are connected to the first and second gate lines to which the first and second scanning pulse signals are supplied, respectively.

7. A driving method for a display apparatus according to claim 6, wherein the second scanning pulse signal is applied to said second gate lines after the first scanning pulse signal is applied to said first gate lines but prior to a writing timing into a First pixel in the horizontal scanning direction from among the pixels connected to each of said second gate lines.

8. A driving method for a display apparatus according to claim 7, wherein the phase delay of the second scanning pulse signal from the first scanning pulse signal is approximately one half a horizontal scanning period.

9. A driving method for a display apparatus according to claim 6, wherein display elements of the pixels are liquid crystal cells.
